(19) United States
(12) Patent Application Publication
(10) Pub. No.: US 2025/0351136 A1
(43) Pub. Date: Nov. 13, 2025

(54) CONDITIONAL LOGICAL CHANNEL PRIORITIZATION AND RESTRICTION

(71) Applicant: QUALCOMM Incorporated, San Diego, CA (US)

(72) Inventor: Linhai HE, San Diego, CA (US)

(21) Appl. No.: 19/200,410

(22) Filed: May 6, 2025

Related U.S. Application Data
(60) Provisional application No. 63/644,310, filed on May 8, 2024.

(51) Int. Cl. H04W 72/1268

(52) U.S. Cl. CPC H04W 72/1268

(57) ABSTRACT

Methods, systems, and devices for wireless communications are described. In some wireless communications systems, a user equipment (UE) may support communication of different types of traffic within a logical channel. In some examples, the different types of traffic may correspond to different quality of service (QoS) thresholds, different latency thresholds, different priority levels, or any combination thereof. The UE may support conditional logical channel prioritization (LCP) and restriction for a logical channel to support the different types of traffic. For example, the UE may receive configuration signaling that indicates first LCP information for a first traffic class of a logical channel and second LCP information for a second traffic class of the logical channel. If the UE receives an uplink grant, the UE may determine which data to transmit in a corresponding uplink resource based on the different LCP information for the different traffic classes of the logical channel.

### CROSS REFERENCES

The present application for Patent claims the benefit of U.S. Provisional Patent Application No. 63/644,310 by HE, entitled “CONDITIONAL LOGICAL CHANNEL PRIORITIZATION AND RESTRICTION,” filed May 8, 2024, assigned to the assignee hereof, and expressly incorporated herein by reference in its entirety.

### FIELD OF TECHNOLOGY

The following relates to wireless communications, including conditional logical channel prioritization (LCP) and restriction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A user equipment (UE) for wireless communications is described. The UE may include one or more memories storing processor executable code, and one or more processors coupled with the one or more memories. The one or more processors may individually or collectively be operable to execute the code to cause the UE to receive configuration signaling that indicates first logical channel prioritization (LCP) information for a first traffic class of a logical channel and second LCP information for a second traffic class of the logical channel, receive an uplink grant indicating an uplink resource, and transmit, via the uplink resource, a subset of data from a data buffer based on the subset of data corresponding to the first traffic class and the first LCP information indicating at least one of support for the uplink grant or a priority value of the subset of data.

A method for wireless communications at a UE is described. The method may include receiving configuration signaling that indicates first LCP information for a first traffic class of a logical channel and second LCP information for a second traffic class of the logical channel, receiving an uplink grant indicating an uplink resource, and transmitting, via the uplink resource, a subset of data from a data buffer based on the subset of data corresponding to the first traffic class and the first LCP information indicating at least one of support for the uplink grant or a priority value of the subset of data.

Another UE for wireless communications is described. The UE may include means for receiving configuration signaling that indicates first LCP information for a first traffic class of a logical channel and second LCP information for a second traffic class of the logical channel, means for receiving an uplink grant indicating an uplink resource, and means for transmitting, via the uplink resource, a subset of data from a data buffer based on the subset of data corresponding to the first traffic class and the first LCP information indicating at least one of support for the uplink grant or a priority value of the subset of data.

A non-transitory computer-readable medium storing code for wireless communications is described. The code may include instructions executable by one or more processors to receive configuration signaling that indicates first LCP information for a first traffic class of a logical channel and second LCP information for a second traffic class of the logical channel, receive an uplink grant indicating an uplink resource, and transmit, via the uplink resource, a subset of data from a data buffer based on the subset of data corresponding to the first traffic class and the first LCP information indicating at least one of support for the uplink grant or a priority value of the subset of data.

Some examples of the method, UEs, and non-transitory computer-readable medium described herein may further include operations, features, means, or instructions for refraining from transmitting a second subset of data from the data buffer based on the second subset of data corresponding to the second traffic class and the second LCP information indicating at least one of restriction of the uplink grant or a second priority value of the second subset of data that is lower than the priority value.

In some examples of the method, UEs, and non-transitory computer-readable medium described herein, the subset of data may be transmitted based on the first LCP information indicating the priority value of the subset of data, where the priority value of the subset of data is higher than a second priority value of a second subset of data from the data buffer corresponding to the second traffic class.

Some examples of the method, UEs, and non-transitory computer-readable medium described herein may further include operations, features, means, or instructions for receiving second configuration signaling that indicates one or more time thresholds, one or more packet filters, or a combination thereof, where data of the data buffer corresponds to a respective traffic class of a set of multiple traffic classes based on at least one of the one or more time thresholds or the one or more packet filters.

Some examples of the method, UEs, and non-transitory computer-readable medium described herein may further include operations, features, means, or instructions for assigning a traffic class to a data unit of the data based on a remaining time of a discard timer associated with the data unit failing to satisfy a time threshold of the one or more time thresholds. Some examples of the method, UEs, and non-transitory computer-readable medium described herein may further include operations, features, means, or instructions for updating the traffic class assigned to the data unit based on the discard timer associated with the data unit satisfying the time threshold of the one or more time thresholds.

Some examples of the method, UEs, and non-transitory computer-readable medium described herein may further include operations, features, means, or instructions for assigning a traffic class to a data unit of the data based on a header of the data unit and a packet filter of the one or more packet filters. In some examples of the method, UEs, and non-transitory computer-readable medium described herein, the traffic class may be assigned to the data unit based on the header indicating a level of importance for the data unit. In some examples of the method, UEs, and non-transitory computer-readable medium described herein, the traffic class may be assigned to the data unit based on the header indicating that the data unit includes data, acknowledgment information, or both.

Some examples of the method, UEs, and non-transitory computer-readable medium described herein may further include operations, features, means, or instructions for determining that the first traffic class supports the uplink grant based on one or more parameters of the uplink grant and the first LCP information for the first traffic class.

In some examples of the method, UEs, and non-transitory computer-readable medium described herein, the second traffic class corresponds to a default traffic class. In some examples of the method, UEs, and non-transitory computer-readable medium described herein, the second LCP information includes baseline LCP restriction parameters, and the first LCP information includes a subset of the baseline LCP restriction parameters and one or more relaxed LCP restriction parameters. In some examples of the method, UEs, and non-transitory computer-readable medium described herein, the second LCP information indicates a default priority value and the priority value indicated by the first LCP information includes a second priority value that may be higher than the default priority value.

In some examples of the method, UEs, and non-transitory computer-readable medium described herein, the first LCP information indicates one or more first LCP parameters, one or more first LCP restriction parameters, or both, and the second LCP information indicates one or more second LCP parameters, one or more second LCP restriction parameters, or both.

In some examples of the method, UEs, and non-transitory computer-readable medium described herein, the first LCP information indicates at least one of an allowed subcarrier spacing (SCS) list parameter, a threshold physical uplink shared channel (PUSCH) duration parameter, a configured grant (CG) type 1 allowed parameter, an allowed serving cells parameter, an allowed CG list parameter, an allowed physical priority index parameter, or an allowed hybrid automatic repeat request (HARQ) mode parameter.

In some examples of the method, UEs, and non-transitory computer-readable medium described herein, the configuration signaling includes a radio resource control (RRC) message.

Details of one or more implementations of the subject matter described in this disclosure are set forth in the accompanying drawings and the description below. Other features and aspects will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support conditional logical channel prioritization (LCP) and LCP restriction in accordance with one or more aspects of the present disclosure.

FIG. 3 shows an example of a process flow that supports conditional LCP and LCP restriction in accordance with one or more aspects of the present disclosure.

FIGS. 4 and 5 show block diagrams of devices that support conditional LCP and LCP restriction in accordance with one or more aspects of the present disclosure.

FIG. 6 shows a block diagram of a communications manager that supports conditional LCP and LCP restriction in accordance with one or more aspects of the present disclosure.

FIG. 7 shows a diagram of a system including a device that supports conditional LCP and LCP restriction in accordance with one or more aspects of the present disclosure.

FIGS. 8 through 10 show flowcharts illustrating methods that support conditional LCP and LCP restriction in accordance with one or more aspects of the present disclosure.

### DETAILED DESCRIPTION

Some wireless communications systems may support multiple logical channels for communication. A logical channel may carry specific types of traffic with quality of service (QoS) characteristics that are supported by the logical channel. A network entity may configure logical channel prioritization (LCP) information, such as prioritization parameters, restriction parameters, or both, for a user equipment (UE). In some cases, the network may configure LCP information for each logical channel supported by the UE. If the UE receives an uplink grant, the UE may determine which data to transmit in a corresponding uplink resource based on the LCP information. For example, LCP restriction information may indicate whether a logical channel supports using the uplink grant, and LCP prioritization information may indicate transmission priorities for different logical channels. However, in some cases, handling prioritization and restriction information at the logical channel-level may fail to account for differences in data within a logical channel. For example, different data associated with the same logical channel may correspond to different priorities, different latency thresholds, different importances, or any combination thereof. Accordingly, using LCP information for logical channels may reduce the efficiency, reliability, or both of communications for a UE.

As described herein, a UE may support conditional LCP information (e.g., prioritization information, restriction information, or both) for logical channels. Specifically, the UE may differentiate LCP information for different sets of data associated with the same logical channel to improve the robustness of data handling. A network entity may transmit configuration signaling to the UE indicating different LCP information for different traffic classes of a same logical channel. For example, the configuration signaling may indicate at least first LCP information for a first traffic class of a logical channel and second LCP information for a second traffic class of the logical channel. The UE may support any quantity of traffic classes within a logical channel, and different logical channels may have different quantities of traffic classes. The LCP information for a traffic class may indicate prioritization information for the traffic class, restriction information for the traffic class, or both. If the UE receives an uplink grant indicating an uplink resource, the UE may determine which data to transmit via the uplink resource based on the LCP information for the different traffic classes. For example, the UE may determine to transmit a subset of data from a data buffer if the subset of data corresponds to a traffic class with LCP restriction information that supports the uplink grant, LCP prioritization information that prioritizes transmission of the subset of data (e.g., relative to other subsets of data in the data buffer), or both.

The UE may improve communication efficiency and reliability by using more granular LCP information (e.g., at the traffic class-level, as opposed to the logical channel-level). In some examples, the UE may use the traffic class-specific LCP information to effectively prioritize transmission of data with relatively low latency thresholds, improving support for satisfying latency thresholds of delay-sensitive data. Additionally, or alternatively, the UE may use the traffic class-specific LCP information to effectively prioritize transmission of information with relatively high importance, such as mission critical data or acknowledgment information. In some cases, prioritizing these transmissions may improve the reliability of other procedures that depend on this information, such as feedback procedures depending on the successful communication of acknowledgment information, improving the processing overhead associated with such procedures. By supporting different LCP information for different traffic classes within a same logical channel, the UE may improve the handling and prioritization of logical channel data, improving communication reliability and efficiency.

Aspects of the disclosure are initially described in the context of wireless communications systems and process flows. Aspects of the disclosure are further illustrated by and described with reference to apparatus diagrams, system diagrams, and flowcharts that relate to conditional LCP and LCP restriction.

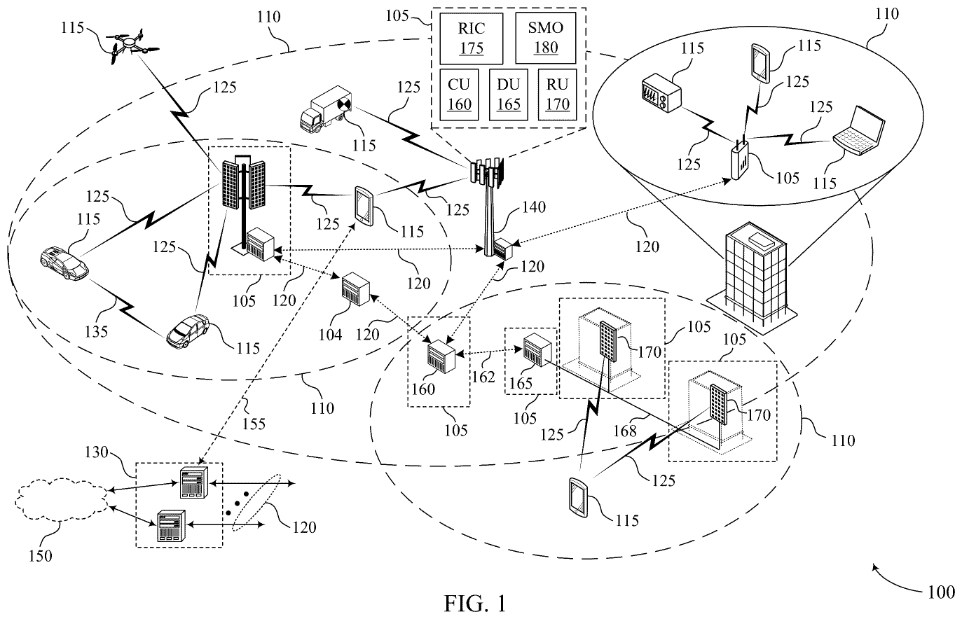

FIG. 1 shows an example of a wireless communications system 100 that supports conditional LCP and LCP restriction in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

UEs 115 and network entities 105 may communicate via one or more logical channels. A logical channel may carry a specific type of data, where different logical channels carry different types of data. For example, different logical channels may support different applications, different traffic flows with different quality of service (QoS) thresholds, or both. In some examples, devices may use a single logical channel for communicating different traffic flows with similar QoS thresholds or characteristics supported by the logical channel. In some cases, a logical channel may be a control channel (e.g., supporting the transfer of data from the control plane) or a traffic channel (e.g., supporting the transfer of data from the user plane). Logical channels may be defined at the MAC layer. Some example logical channels may include an audio data channel, a video data channel, a control channel, or any combination of these or other logical channels.

A logical channel may be configured with LCP information (e.g., restriction information, prioritization information, or both). In some cases, a network entity 105 may configure the LCP information per logical channel, such that all traffic within the same logical channel is handled in the same manner (e.g., according to LCP and LCP restriction). The network may configure the logical channel with one or more LCP restrictions. An LCP restriction may indicate whether the logical channel is allowed to use an uplink grant based on properties of the uplink grant (e.g., on which carrier the uplink grant is scheduled, whether the uplink grant is a configured grant (CG)). If a UE 115 receives an uplink grant (e.g., from a network entity 105), the UE 115 may determine whether to transmit data for a logical channel based on whether the LCP restriction information for that logical channel indicates support for the uplink grant (e.g., based on the properties of the uplink grant). An LCP (e.g., indicating prioritization information) may configure a priority for a logical channel. The UE 115 may use the LCP during an uplink multiplexing procedure to prioritize data for transmission based on an uplink grant. For example, if the UE 115 receives an uplink grant that is available for multiple logical channels (e.g., based on the LCP restrictions for these logical channels), the UE 115 may schedule the transmission of data for the logical channels with relatively higher priorities based on the LCPs for the logical channels.

However, in some cases, different data may correspond to differentiated treatment within the same logical channel. For example, some data within a logical channel may have relatively higher priority, relatively lower latency thresholds, different QoS parameters, or any combination thereof compared to other data within the same logical channel. In some examples, a logical channel may carry delay-sensitive or delay-critical data. Data with a remaining time for transmission below a threshold may be relatively more urgent for transmission than other data, corresponding to different levels of priority for transmitting data with different amounts of remaining time left for transmission (e.g., prior to discarding the data). In some other examples, data may be associated with a protocol data unit (PDU) set. For example, sets of video frames may be communicated using PDU sets, where some frames are relatively more important based on compression algorithms (e.g., based on the important frames being used as references for determining other frames). Accordingly, data corresponding to relatively high PDU set importance (PSI) values within a PDU set may correspond to a different priority for transmission than other (relatively less important) data. Additionally, or alternatively, acknowledgment information may correspond to a different priority than data. For example, handling acknowledgment information with a higher priority than other data may improve throughput and the reliability of HARQ procedures.

To support such differentiated treatment of data within a logical channel, a UE 115 may support conditional LCP and LCP restriction for a logical channel. Specifically, different classes of data (e.g., different traffic classes) within a logical channel may correspond to different LCPs (e.g., different prioritizations), different LCP restrictions, or a combination thereof.

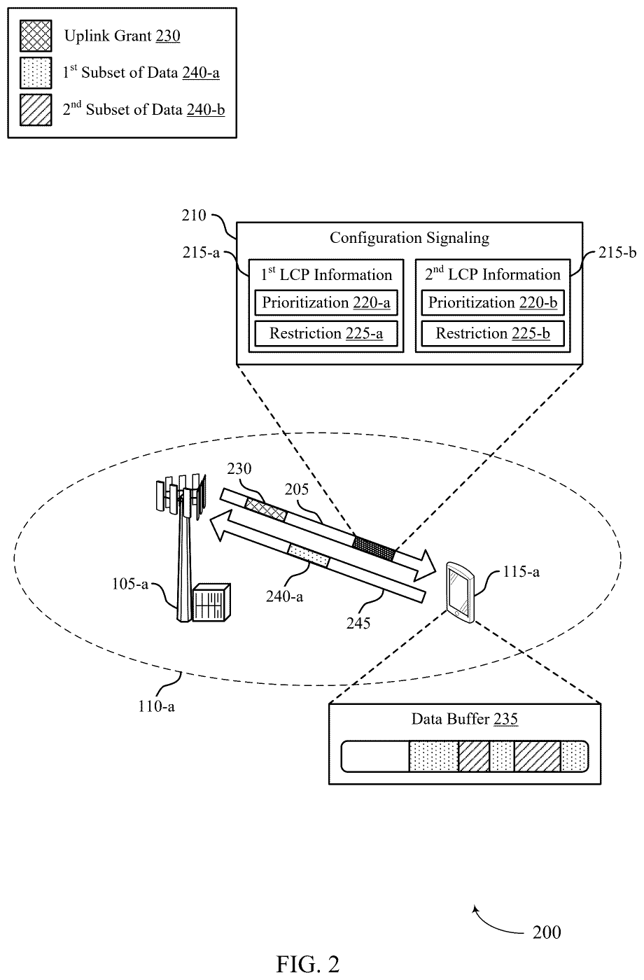

FIG. 2 shows an example of a wireless communications system 200 that supports conditional LCP and LCP restriction in accordance with one or more aspects of the present disclosure. The wireless communications system 200 may include a UE 115-a and a network entity 105-a. The network entity 105-a may serve a coverage area 110-a.

The UE 115-a may support traffic classification. For example, the UE 115-a may classify traffic (e.g., data units, such as service data units (SDUs), protocol data units (PDUs), or both) within the same logical channel into one of multiple classes. In some examples, the UE 115-a may be pre-configured with traffic classifications. In some other examples, the network entity 105-a may transmit configuration signaling 210 configuring the traffic classifications. In some cases, the UE 115-a may classify traffic based on one or more time thresholds. For example, an SDU may have a remaining time for transmission (e.g., until the SDU is dropped or otherwise determined to fail transmission). The remaining time for the SDU may be defined as the remaining time of a packet data convergence protocol (PDCP) discard timer associated with the corresponding PDU. Upon expiration of the PDCP discard timer, the UE 115-a may discard the associated PDU pending for transmission. The UE 115-a may classify traffic based on the time remaining until discarding the data unit. In some cases, the network may configure the UE 115-a with one or more remaining time thresholds (e.g., T1, T2,T3, etc.). A first traffic class may include SDUs with a remaining time less than T1, and a second traffic class may include SDUs with a remining time between T1 and T2. The UE 115-a may track any quantity of traffic classes using any quantity of time thresholds. Using these different traffic classes, the UE 115-a may prioritize transmitting data with relatively low remaining times to refrain from dropping the data.

In some examples, the UE 115-a may change the traffic class of a PDU over time. For example, as the PDCP discard timer runs, the remaining time for the SDU decreases. The UE 115-a may switch an SDU from the second traffic class to the first traffic class based on the PDCP discard timer or the remaining time satisfying the T1 time threshold (e.g., the remaining time for the SDU falling below T1).

Additionally, or alternatively, the UE 115-a may classify traffic based on one or more packet filters. For example, the network may configure a packet filter for a logical channel. The packet filter may filter data units based on a selected set of header fields in upper-layer protocols. For example, SDUs may be classified based on real time transport protocol (RTP) headers into multiple levels of importance, where different levels of importance may correspond to different traffic classes. Additionally, or alternatively, SDUs may be classified based on transmission control protocol (TCP) header fields into data or acknowledgment information, where different types of information (e.g., data versus acknowledgment information, such as HARQ ACK data) may correspond to different traffic classes.

The network may configure the UE 115-a with LCP information for the different traffic classes. The LCP information may include LCP restriction information, LCP prioritization information, or both. For example, the network may configure LCP restrictions for each traffic class within a logical channel. In some examples, the network entity 105-a may transmit configuration signaling 210 indicating a full set of LCP restriction parameters for each traffic class of the logical channel. In some other examples, the network entity 105-a may transmit configuration signaling 210 indicating a baseline copy of LCP restriction parameters and may designate a default traffic class which applies the baseline LCP restriction parameters. For other traffic classes, the network may additionally specific which LCP restriction parameters may be relaxed (e.g., removed, reduced). For example, the traffic classes may be based on the remaining time for SDUs. The default traffic class may include SDUs with remaining times not below a threshold, T1. The default traffic class may include LCP restrictions limiting the uplink grants that the UE 115-a can use to transmit data of the default traffic class. In contrast, a second traffic class may include SDUs with remaining times below the threshold, T1 (e.g., corresponding to delay-critical data). The second traffic class may have fewer (or no) LCP restrictions, increasing the uplink grants supporting transmission of the delay-critical data and improving the likelihood that the delay-critical data is transmitted (e.g., before expiration of a discard timer for the data).

The LCP restriction information may include one or more of the following LCP restriction parameters. For example, the LCP restrictions may include an allowed subcarrier spacing (SCS) list, allowedSCS-List, which may set the allowed SCSs for transmission. That is, if an uplink grant indicates an uplink resource with one or more of the allowed SCSs for a traffic class, the LCP restrictions may allow for use of this uplink grant for transmission of data of this traffic class. The LCP restrictions may include a threshold physical uplink shared channel (PUSCH) duration, maxPUSCH-Duration, which may set a threshold (e.g., maximum) PUSCH duration allowed for transmission. The LCP restrictions may include a CG type 1 allowed parameter, configuredGrantType1Allowed, which may set whether a CG Type 1 can be used for transmission. The LCP restrictions may include an allowed serving cells parameter, allowedServingCells, which may set the allowed cells for transmission. The LCP restrictions may include an allowed CG list, allowedCG-List, which may set the allowed CGs for transmission. The LCP restrictions may include an allowed PHY layer priority index, allowedPHY-PriorityIndex, which may set the allowed PHY priority indexes of a dynamic grant for transmission. The LCP restrictions may include an allowed HARQ mode, allowedHARQ-mode, which may set the allowed uplink HARQ mode for transmission. In some cases, the LCP restriction information may include any combination of these or other LCP restriction parameters.

Additionally, or alternatively, the network may configure priority values for each traffic class within a logical channel to be used for LCP prioritization. In some cases, the UE 115-a may support two priorities, a default priority and a high priority that is relatively higher than the default priority. In some other cases, the UE 115-a may support any quantity of priority levels. The UE 115-a may have a default traffic class associated with the default priority (e.g., a first priority value). Other traffic classes may be assigned with different priorities (e.g., different priority values, which may be higher priority or lower priority than the first priority value). The UE 115-a may prioritize transmitting data corresponding to relatively higher priority values. In some cases, the UE 115-a may retrieve data from a data buffer 235 for transmission out of order based on selecting data corresponding to relatively higher priorities for transmission. In some cases, if an SDU changes traffic classes (e.g., due to a change in the SDU's remaining time), the SDU may corresponding change its priority (e.g., delay-critical data may be assigned relatively higher priority than other data when being multiplexed into uplink grants).

In some examples, the UE 115-a may use the traffic class-specific LCP information in place of logical channel-specific LCP information. Alternatively, the UE 115-a may use a combination of traffic class-specific LCP information and logical channel-specific LCP information to determine data for transmission.

The network entity 105-a may transmit the configuration signaling 210 via a downlink channel 205 to the UE 115-a. The configuration signaling 210 may be an example of radio resource control (RRC) signaling. The configuration signaling 210 may indicate first LCP information 215-a for a first traffic class, where the first LCP information 215-a include prioritization information 220-a, restriction information 225-a, or both. Additionally, the configuration signaling 210 may indicate second LCP information 215-bfor a second traffic class, where the second LCP information 215-b include prioritization information 220-b, restriction information 225-b, or both. The first and second traffic classes may correspond to data associated with a same logical channel, such that the first and second LCP information provides conditional LCP parameters for data within the logical channel. The UE 115-a may use the configuration signaling 210 and traffic classifications to determine (e.g., select) data for transmission. If the UE 115-a receives an uplink grant 230 (e.g., transmitted by the network entity 105-a), the UE 115-a may determine what data to transmit using the granted uplink resources based on the configured LCP information. For example, the UE 115-a may maintain a data buffer 235 with data for transmission. The data buffer 235 may include a first subset of data 240-a for a logical channel and a second subset of data 240-b for the logical channel, where the first subset of data 240-a corresponds to the first traffic class and the second subset of data 240-b corresponds to the second traffic class. The UE 115-a may determine to transmit the first subset of data 240-b via an uplink channel 245 in response to the uplink grant 230 based on the first LCP information 215-a for the first traffic class indicating support for the uplink grant 230, prioritization of the first subset of data 240-a (e.g., over the second subset of data 240-b), or both.

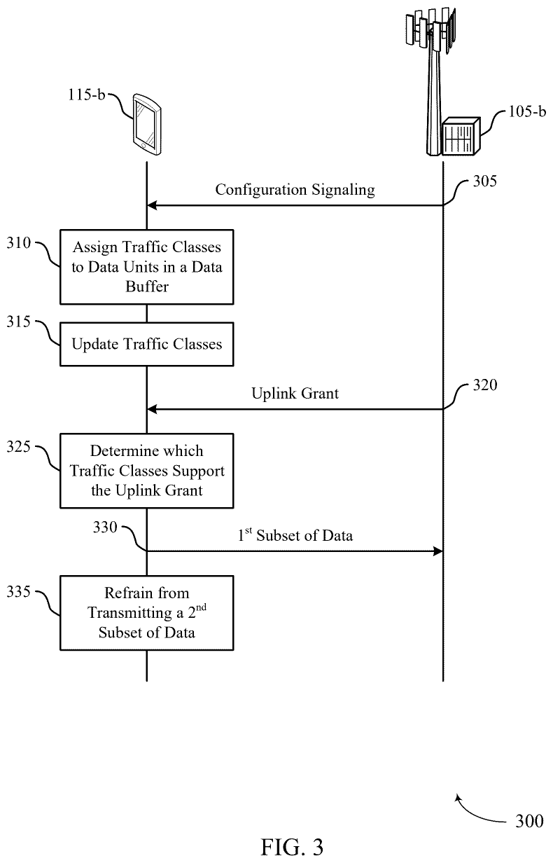

FIG. 3 shows an example of a process flow 300 that supports conditional LCP and LCP restriction in accordance with one or more aspects of the present disclosure. A UE 115-b and a network entity 105-b may perform the operations of the process flow 300. For example, at 305, the UE 115-b may receive configuration signaling from the network entity 105-b. The configuration signaling may be RRC signaling (e.g., one or more RRC messages). The configuration signaling may indicate LCP information for one or more traffic classes. For example, the configuration signaling may indicate first LCP information for a first traffic class of a logical channel and second LCP information for a second traffic class of the logical channel. Additionally, or alternatively, the configuration signaling may indicate information defining the different traffic classes. For example, the configuration signaling may indicate one or more time thresholds, one or more packet filters, or a combination thereof to separate data for a logical channel into the different traffic classes.

At 310, the UE 115-b may assign traffic classes to data units in a data buffer of the UE 115-b. For example, based on the configuration signaling, the UE 115-b may classify the data in the data buffer. Data of the data buffer may correspond to a respective traffic class based on one or more time thresholds, one or more packet filters, or a combination thereof. The UE 115-b may assign a traffic class to a data unit of the data based on a remaining time of a discard timer associated with the data unit failing to satisfy a time threshold of the one or more time thresholds. Additionally, or alternatively, the UE 115-b may assign a traffic class to the data unit of the data based on a header of the data unit (e.g., the header indicating a level of importance for the data unit, the header indicating that the data unit includes data or acknowledgment information) and a packet filter of the one or more packet filters. In some cases, at 315, the UE 115-b may update the traffic class assigned to a data unit. For example, the UE 115-b may update the traffic class based on the discard timer associated with the data unit satisfying the time threshold of the one or more time thresholds.

At 320, the network entity 105-b may transmit an uplink grant to the UE 115-b. The UE 115-b may receive the uplink grant indicating an uplink resource. At 325, the UE 115-b may determine which traffic classes support the uplink grant. For example, the UE 115-b may determine a first subset of data to transmit using the uplink grant based on the first subset of data corresponding to a first traffic class with LCP information that indicates support for the uplink grant, prioritization of the first subset of data, or both. At 330, the UE 115-b may transmit, via the uplink resource, the first subset of data from the data buffer based on the LCP information for the first subset of data's traffic class. Additionally, or alternatively, at 335, the UE 115-b may refrain from transmitting a second subset of data from the data buffer for the uplink grant based on the LCP information for the second subset of data's traffic class. For example, the second subset of data may correspond to a second traffic class with second LCP information that indicates restriction of the uplink grant (e.g., no support for the uplink grant), a relatively lower priority for the second subset of data (e.g., compared to the first subset of data), or both.

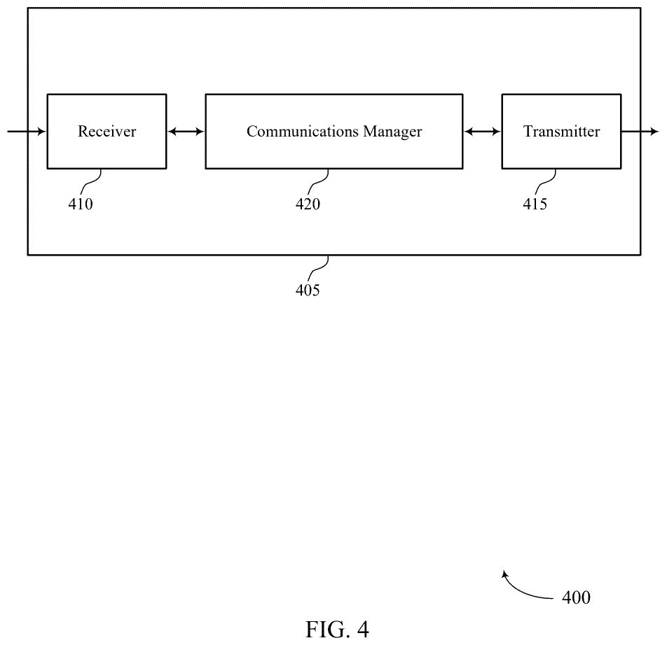

FIG. 4 shows a block diagram 400 of a device 405 that supports conditional LCP and LCP restriction in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to conditional LCP and LCP restriction). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to conditional LCP and LCP restriction). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of conditional LCP and LCP restriction as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving configuration signaling that indicates first LCP information for a first traffic class of a logical channel and second LCP information for a second traffic class of the logical channel. The communications manager 420 is capable of, configured to, or operable to support a means for receiving an uplink grant indicating an uplink resource. The communications manager 420 is capable of, configured to, or operable to support a means for transmitting, via the uplink resource, a subset of data from a data buffer based on the subset of data corresponding to the first traffic class and the first LCP information indicating at least one of support for the uplink grant or a priority value of the subset of data.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources. For example, by differentiating LCP information (e.g., prioritization, restriction, or both) between different traffic classes for a same logical channel, the device 405 may support improved handling of different types of traffic. For example, the device 405 may support relatively more granular prioritization and restriction of data beyond the logical channel-level. This more granular LCP information may reduce the latency associated with latency-sensitive communications, improve the reliability of relatively important (e.g., mission critical) communications, improve the reliability of ACK transmissions, or any combination thereof. Accordingly, the device 405 may reduce a processing overhead associated with communications by using the different LCP information for different traffic classes within a logical channel.

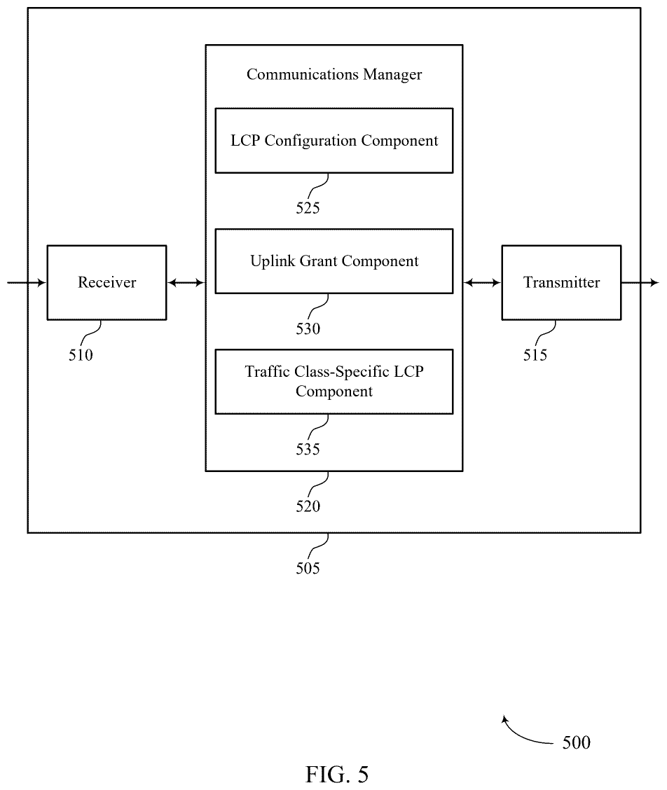

FIG. 5 shows a block diagram 500 of a device 505 that supports conditional LCP and LCP restriction in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to conditional LCP and LCP restriction). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to conditional LCP and LCP restriction). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of conditional LCP and LCP restriction as described herein. For example, the communications manager 520 may include an LCP configuration component 525, an uplink grant component 530, a traffic class-specific LCP component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The LCP configuration component 525 is capable of, configured to, or operable to support a means for receiving configuration signaling that indicates first LCP information for a first traffic class of a logical channel and second LCP information for a second traffic class of the logical channel. The uplink grant component 530 is capable of, configured to, or operable to support a means for receiving an uplink grant indicating an uplink resource. The traffic class-specific LCP component 535 is capable of, configured to, or operable to support a means for transmitting, via the uplink resource, a subset of data from a data buffer based on the subset of data corresponding to the first traffic class and the first LCP information indicating at least one of support for the uplink grant or a priority value of the subset of data.

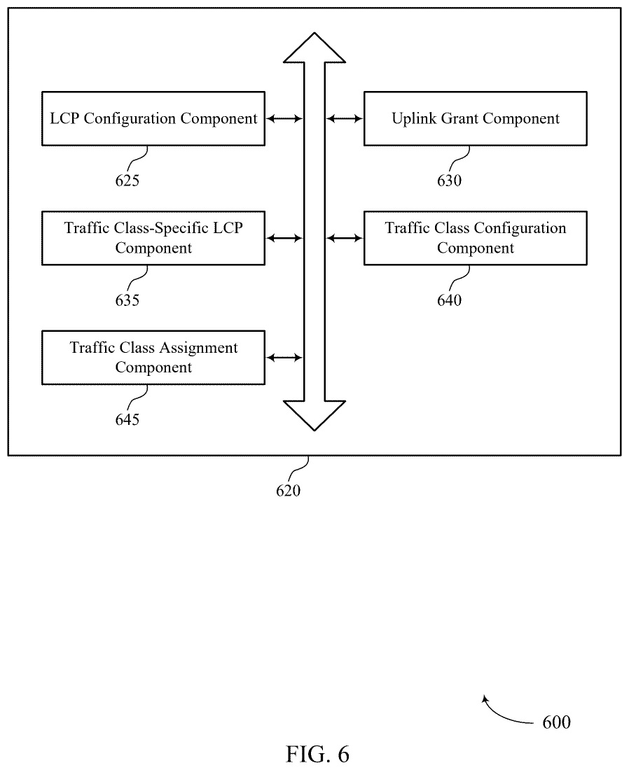

FIG. 6 shows a block diagram 600 of a communications manager 620 that

supports conditional LCP and LCP restriction in accordance with one or more aspects of the present disclosure. The communications manager 620 may be an example of aspects of a communications manager 420, a communications manager 520, or both, as described herein. The communications manager 620, or various components thereof, may be an example of means for performing various aspects of conditional LCP and LCP restriction as described herein. For example, the communications manager 620 may include an LCP configuration component 625, an uplink grant component 630, a traffic class-specific LCP component 635, a traffic class configuration component 640, a traffic class assignment component 645, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The LCP configuration component 625 is capable of, configured to, or operable to support a means for receiving configuration signaling that indicates first LCP information for a first traffic class of a logical channel and second LCP information for a second traffic class of the logical channel. The uplink grant component 630 is capable of, configured to, or operable to support a means for receiving an uplink grant indicating an uplink resource. The traffic class-specific LCP component 635 is capable of, configured to, or operable to support a means for transmitting, via the uplink resource, a subset of data from a data buffer based on: the subset of data corresponding to the first traffic class; and the first LCP information indicating at least one of support for the uplink grant or a priority value of the subset of data.

In some examples, the traffic class-specific LCP component 635 is capable of, configured to, or operable to support a means for refraining from transmitting a second subset of data from the data buffer based on the second subset of data corresponding to the second traffic class and the second LCP information indicating at least one of restriction of the uplink grant or a second priority value of the second subset of data that is lower than the priority value.

In some examples, the subset of data is transmitted based on the first LCP information indicating the priority value of the subset of data, where the priority value of the subset of data is higher than a second priority value of a second subset of data from the data buffer corresponding to the second traffic class.

In some examples, the traffic class configuration component 640 is capable of, configured to, or operable to support a means for receiving second configuration signaling that indicates one or more time thresholds, one or more packet filters, or a combination thereof, where data of the data buffer corresponds to a respective traffic class of a set of multiple traffic classes based on at least one of the one or more time thresholds or the one or more packet filters.

In some examples, the traffic class assignment component 645 is capable of, configured to, or operable to support a means for assigning a traffic class to a data unit of the data based on a remaining time of a discard timer associated with the data unit failing to satisfy a time threshold of the one or more time thresholds. In some examples, the traffic class assignment component 645 is capable of, configured to, or operable to support a means for updating the traffic class assigned to the data unit based on the discard timer associated with the data unit satisfying the time threshold of the one or more time thresholds.

In some examples, the traffic class assignment component 645 is capable of, configured to, or operable to support a means for assigning a traffic class to a data unit of the data based on a header of the data unit and a packet filter of the one or more packet filters. In some examples, the traffic class is assigned to the data unit based on the header indicating a level of importance for the data unit. In some examples, the traffic class is assigned to the data unit based on the header indicating that the data unit includes data, acknowledgment information, or both.

In some examples, the traffic class-specific LCP component 635 is capable of, configured to, or operable to support a means for determining that the first traffic class supports the uplink grant based on one or more parameters of the uplink grant and the first LCP information for the first traffic class.

In some examples, the second traffic class corresponds to a default traffic class. In some examples, the second LCP information includes baseline LCP restriction parameters. In some such examples, the first LCP information includes a subset of the baseline LCP restriction parameters and one or more relaxed LCP restriction parameters. In some examples, the second LCP information indicates a default priority value. In some such examples, the priority value indicated by the first LCP information includes a second priority value that is higher than the default priority value.

In some examples, the first LCP information indicates one or more first LCP parameters, one or more first LCP restriction parameters, or both. In some such examples, the second LCP information indicates one or more second LCP parameters, one or more second LCP restriction parameters, or both.

In some examples, the first LCP information, the second LCP information, or both indicate at least one of an allowed SCS list parameter, a threshold PUSCH duration parameter, a CG Type 1 allowed parameter, an allowed serving cells parameter, an allowed CG list parameter, an allowed physical priority index parameter, or an allowed HARQ mode parameter.

In some examples, the configuration signaling includes RRC signaling, such as one or more RRC messages.

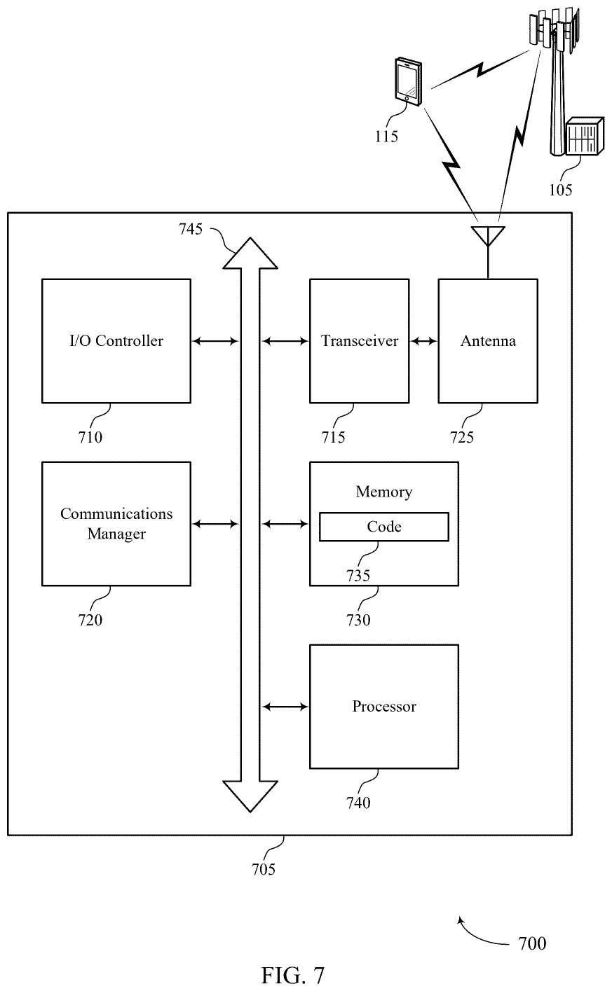

FIG. 7 shows a diagram of a system 700 including a device 705 that supports conditional LCP and LCP restriction in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting conditional LCP and LCP restriction). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving configuration signaling that indicates first LCP information for a first traffic class of a logical channel and second LCP information for a second traffic class of the logical channel. The communications manager 720 is capable of, configured to, or operable to support a means for receiving an uplink grant indicating an uplink resource. The communications manager 720 is capable of, configured to, or operable to support a means for transmitting, via the uplink resource, a subset of data from a data buffer based on the subset of data corresponding to the first traffic class and the first LCP information indicating at least one of support for the uplink grant or a priority value of the subset of data.

By including or configuring the communications manager 720 in accordance with examples as described herein, the device 705 may support techniques for improved communication reliability, reduced latency, and more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of conditional LCP and LCP restriction as described herein, or the at least one processor 740 and the at least one memory 730 may be otherwise configured to, individually or collectively, perform or support such operations.

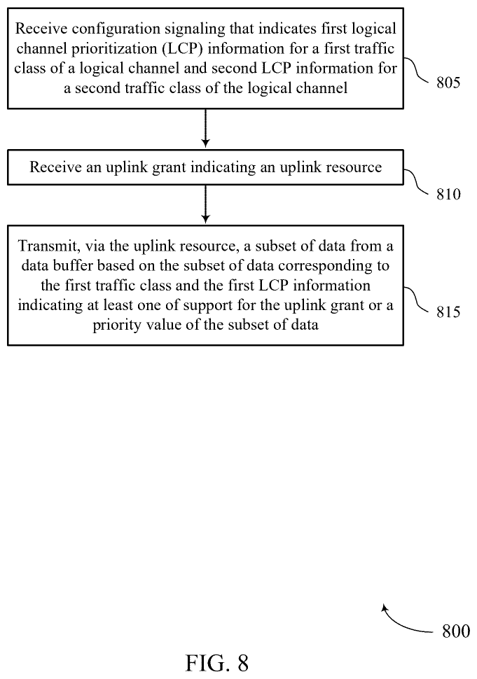

FIG. 8 shows a flowchart illustrating a method 800 that supports conditional LCP and LCP restriction in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving configuration signaling that indicates first LCP information for a first traffic class of a logical channel and second LCP information for a second traffic class of the logical channel. The operations of 805 may be performed in accordance with examples as disclosed herein. In some examples, aspects of the operations of 805 may be performed by an LCP configuration component 625 as described with reference to FIG. 6.

At 810, the method may include receiving an uplink grant indicating an uplink resource. The operations of 810 may be performed in accordance with examples as disclosed herein. In some examples, aspects of the operations of 810 may be performed by an uplink grant component 630 as described with reference to FIG. 6.

At 815, the method may include transmitting, via the uplink resource, a subset of data from a data buffer based on the subset of data corresponding to the first traffic class and based on the first LCP information indicating support for the uplink grant, a priority value of the subset of data (e.g., prioritizing the subset of data over other data in the data buffer), or both. The operations of 815 may be performed in accordance with examples as disclosed herein. In some examples, aspects of the operations of 815 may be performed by a traffic class-specific LCP component 635 as described with reference to FIG. 6.

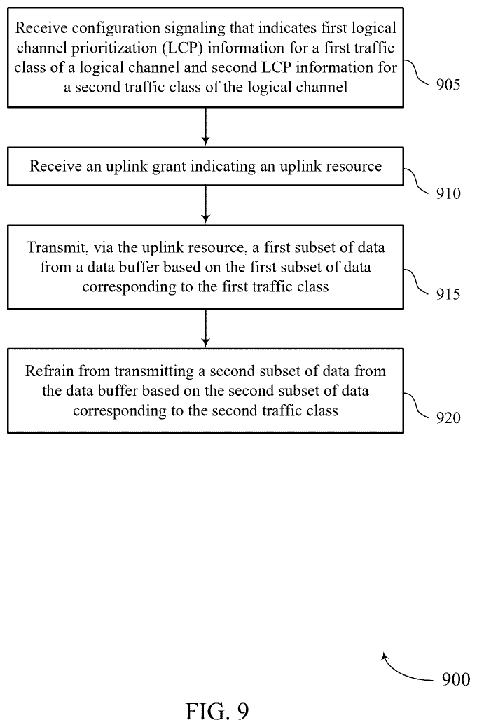

FIG. 9 shows a flowchart illustrating a method 900 that supports conditional LCP and LCP restriction in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving configuration signaling that indicates first LCP information for a first traffic class of a logical channel and second LCP information for a second traffic class of the logical channel. The operations of 905 may be performed in accordance with examples as disclosed herein. In some examples, aspects of the operations of 905 may be performed by an LCP configuration component 625 as described with reference to FIG. 6.

At 910, the method may include receiving an uplink grant indicating an uplink resource. The operations of 910 may be performed in accordance with examples as disclosed herein. In some examples, aspects of the operations of 910 may be performed by an uplink grant component 630 as described with reference to FIG. 6.

At 915, the method may include transmitting, via the uplink resource, a first subset of data from a data buffer based on the first subset of data corresponding to the first traffic class and based on the first LCP information indicating at least one of support for the uplink grant or a first priority value of the first subset of data. The operations of 915 may be performed in accordance with examples as disclosed herein. In some examples, aspects of the operations of 915 may be performed by a traffic class-specific LCP component 635 as described with reference to FIG. 6.

At 920, the method may include refraining from transmitting a second subset of data from the data buffer based on the second subset of data corresponding to the second traffic class and based on the second LCP information indicating at least one of restriction of the uplink grant or a second priority value of the second subset of data that is lower than the first priority value. The operations of 920 may be performed in accordance with examples as disclosed herein. In some examples, aspects of the operations of 920 may be performed by a traffic class-specific LCP component 635 as described with reference to FIG. 6.

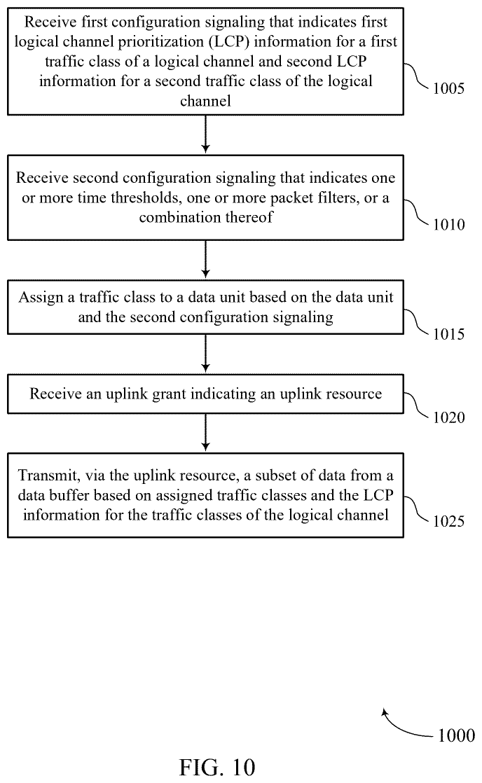

FIG. 10 shows a flowchart illustrating a method 1000 that supports conditional LCP and LCP restriction in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving first configuration signaling that indicates first LCP information for a first traffic class of a logical channel and second LCP information for a second traffic class of the logical channel. The operations of 1005 may be performed in accordance with examples as disclosed herein. In some examples, aspects of the operations of 1005 may be performed by an LCP configuration component 625 as described with reference to FIG. 6.

At 1010, the method may include receiving second configuration signaling that indicates one or more time thresholds, one or more packet filters, or a combination thereof for traffic classification. In some examples, the first configuration signaling and the second configuration signaling may be the same configuration signaling (e.g., the same RRC signaling, a same RRC message). The operations of 1010 may be performed in accordance with examples as disclosed herein. In some examples, aspects of the operations of 1010 may be performed by a traffic class configuration component 640 as described with reference to FIG. 6.

At 1015, the method may include assigning a traffic class to a data unit based on the second configuration signaling. In some examples, the method may include assigning the traffic class to the data unit based on a remaining time of a discard timer associated with the data unit failing to satisfy a time threshold of the one or more time thresholds. Additionally, or alternatively, the method may include assigning the traffic class to the data unit based on a header of the data unit and a packet filter of the one or more packet filters. The operations of 1015 may be performed in accordance with examples as disclosed herein. In some examples, aspects of the operations of 1015 may be performed by a traffic class assignment component 645 as described with reference to FIG. 6.

At 1020, the method may include receiving an uplink grant indicating an uplink resource. The operations of 1020 may be performed in accordance with examples as disclosed herein. In some examples, aspects of the operations of 1020 may be performed by an uplink grant component 630 as described with reference to FIG. 6.

At 1025, the method may include transmitting, via the uplink resource, a subset of data (e.g., data units) from a data buffer based on the assigned traffic classes and the LCP information for the traffic classes of the logical channel. The operations of 1025 may be performed in accordance with examples as disclosed herein. In some examples, aspects of the operations of 1025 may be performed by a traffic class-specific LCP component 635 as described with reference to FIG. 6.

The following provides an overview of aspects of the present disclosure:

Aspect 1: A method for wireless communications at a UE, comprising: receiving configuration signaling that indicates first LCP information for a first traffic class of a logical channel and second LCP information for a second traffic class of the logical channel; receiving an uplink grant indicating an uplink resource; and transmitting, via the uplink resource, a subset of data from a data buffer based at least in part on: the subset of data corresponding to the first traffic class, and the first LCP information indicating at least one of support for the uplink grant or a priority value of the subset of data.

Aspect 2: The method of aspect 1, further comprising: refraining from transmitting a second subset of data from the data buffer based at least in part on the second subset of data corresponding to the second traffic class and the second LCP information indicating at least one of restriction of the uplink grant or a second priority value of the second subset of data that is lower than the priority value.

Aspect 3: The method of either of aspects 1 or 2, further comprising: receiving second configuration signaling that indicates one or more time thresholds, one or more packet filters, or a combination thereof, wherein data of the data buffer corresponds to a respective traffic class of a plurality of traffic classes based at least in part on at least one of the one or more time thresholds or the one or more packet filters.

Aspect 4: The method of aspect 3, further comprising: assigning a traffic class to a data unit of the data based at least in part on a remaining time of a discard timer associated with the data unit failing to satisfy a time threshold of the one or more time thresholds.

Aspect 5: The method of aspect 4, further comprising: updating the traffic class assigned to the data unit based at least in part on the discard timer associated with the data unit satisfying the time threshold of the one or more time thresholds.

Aspect 6: The method of any of aspects 3 through 5, further comprising: assigning a traffic class to a data unit of the data based at least in part on a header of the data unit and a packet filter of the one or more packet filters.

Aspect 7: The method of aspect 6, wherein: the traffic class is assigned to the data unit based at least in part on the header indicating a level of importance for the data unit.

Aspect 8: The method of either of aspects 6 or 7, wherein: the traffic class is assigned to the data unit based at least in part on the header indicating that the data unit comprises data, acknowledgment information, or both.

Aspect 9: The method of any of aspects 1 through 8, further comprising: determining that the first traffic class supports the uplink grant based at least in part on one or more parameters of the uplink grant and the first LCP information for the first traffic class.

Aspect 10: The method of any of aspects 1 through 9, wherein: the second traffic class corresponds to a default traffic class.

Aspect 11: The method of aspect 10, wherein: the second LCP information comprises baseline LCP restriction parameters; and the first LCP information comprises a subset of the baseline LCP restriction parameters and one or more relaxed LCP restriction parameters.

Aspect 12: The method of either of aspects 10 or 11, wherein: the second LCP information indicates a default priority value; and the priority value indicated by the first LCP information comprises a second priority value that is higher than the default priority value.

Aspect 13: The method of any of aspects 1 through 12, wherein: the first LCP information indicates one or more first LCP parameters, one or more first LCP restriction parameters, or both; and the second LCP information indicates one or more second LCP parameters, one or more second LCP restriction parameters, or both.

Aspect 14: The method of any of aspects 1 through 13, wherein: the first LCP information indicates at least one of an allowed SCS list parameter, a threshold PUSCH duration parameter, a CG Type 1 allowed parameter, an allowed serving cells parameter, an allowed CG list parameter, an allowed physical priority index parameter, or an allowed HARQ mode parameter.

Aspect 15: The method of any of aspects 1 through 14, wherein: the configuration signaling comprises an RRC message.

Aspect 16: The method of any of aspects 1 through 15, wherein: the subset of data is transmitted based at least in part on the first logical channel prioritization information indicating the priority value of the subset of data, wherein the priority value of the subset of data is higher than a second priority value of a second subset of data from the data buffer corresponding to the second traffic class.

Aspect 17: A UE for wireless communications, comprising one or more memories storing processor-executable code, and one or more processors coupled with the one or more memories and individually or collectively operable to execute the code to cause the UE to perform a method of any of aspects 1 through 16.

Aspect 18: A UE for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration signaling that indicates first logical channel prioritization information for a first traffic class of a logical channel and second logical channel prioritization information for a second traffic class of the logical channel;
receive an uplink grant indicating an uplink resource; and
transmit, via the uplink resource, a subset of data from a data buffer based at least in part on:
the subset of data corresponding to the first traffic class, and
the first logical channel prioritization information indicating at least one of support for the uplink grant or a priority value of the subset of data.

2. The UE of claim 1, wherein the one or more processors are individually or collectively further operable to execute the code to cause the UE to:
refrain from transmitting a second subset of data from the data buffer based at least in part on the second subset of data corresponding to the second traffic class and the second logical channel prioritization information indicating at least one of restriction of the uplink grant or a second priority value of the second subset of data that is lower than the priority value.

3. The UE of claim 1, wherein:
the subset of data is transmitted based at least in part on the first logical channel prioritization information indicating the priority value of the subset of data, wherein the priority value of the subset of data is higher than a second priority value of a second subset of data from the data buffer corresponding to the second traffic class.

4. The UE of claim 1, wherein the one or more processors are individually or collectively further operable to execute the code to cause the UE to:
receive second configuration signaling that indicates one or more time thresholds, one or more packet filters, or a combination thereof, wherein data of the data buffer corresponds to a respective traffic class of a plurality of traffic classes based at least in part on at least one of the one or more time thresholds or the one or more packet filters.

5. The UE of claim 4, wherein the one or more processors are individually or collectively further operable to execute the code to cause the UE to:
assign a traffic class to a data unit of the data based at least in part on a remaining time of a discard timer associated with the data unit failing to satisfy a time threshold of the one or more time thresholds.

6. The UE of claim 5, wherein the one or more processors are individually or collectively further operable to execute the code to cause the UE to:
update the traffic class assigned to the data unit based at least in part on the discard timer associated with the data unit satisfying the time threshold of the one or more time thresholds.

7. The UE of claim 4, wherein the one or more processors are individually or collectively further operable to execute the code to cause the UE to:
assign a traffic class to a data unit of the data based at least in part on a header of the data unit and a packet filter of the one or more packet filters.

8. The UE of claim 7, wherein:
the traffic class is assigned to the data unit based at least in part on the header indicating a level of importance for the data unit.

9. The UE of claim 7, wherein:
the traffic class is assigned to the data unit based at least in part on the header indicating that the data unit comprises data, acknowledgment information, or both.

10. The UE of claim 1, wherein the one or more processors are individually or collectively further operable to execute the code to cause the UE to:
determine that the first traffic class supports the uplink grant based at least in part on one or more parameters of the uplink grant and the first logical channel prioritization information for the first traffic class.

11. The UE of claim 1, wherein:
the second traffic class corresponds to a default traffic class.

12. The UE of claim 11, wherein:
the second logical channel prioritization information comprises baseline logical channel prioritization restriction parameters; and
the first logical channel prioritization information comprises a subset of the baseline logical channel prioritization restriction parameters and one or more relaxed logical channel prioritization restriction parameters.

13. The UE of claim 11, wherein:
the second logical channel prioritization information indicates a default priority value; and
the priority value indicated by the first logical channel prioritization information comprises a second priority value that is higher than the default priority value.

14. The UE of claim 1, wherein:
the first logical channel prioritization information indicates one or more first logical channel prioritization parameters, one or more first logical channel prioritization restriction parameters, or both; and
the second logical channel prioritization information indicates one or more second logical channel prioritization parameters, one or more second logical channel prioritization restriction parameters, or both.

15. The UE of claim 1, wherein:
the first logical channel prioritization information indicates at least one of an allowed subcarrier spacing list parameter, a threshold physical uplink shared channel duration parameter, a configured grant type 1 allowed parameter, an allowed serving cells parameter, an allowed configured grant list parameter, an allowed physical priority index parameter, or an allowed hybrid automatic repeat request mode parameter.

16. The UE of claim 1, wherein:
the configuration signaling comprises a radio resource control message.

17. A method for wireless communications at a user equipment (UE), comprising:
receiving configuration signaling that indicates first logical channel prioritization information for a first traffic class of a logical channel and second logical channel prioritization information for a second traffic class of the logical channel;
receiving an uplink grant indicating an uplink resource; and
transmitting, via the uplink resource, a subset of data from a data buffer based at least in part on:
the subset of data corresponding to the first traffic class, and
the first logical channel prioritization information indicating at least one of support for the uplink grant or a priority value of the subset of data.

18. The method of claim 17, further comprising:
refraining from transmitting a second subset of data from the data buffer based at least in part on the second subset of data corresponding to the second traffic class and the second logical channel prioritization information indicating at least one of restriction of the uplink grant or a second priority value of the second subset of data that is lower than the priority value.

19. The method of claim 17, further comprising:
receiving second configuration signaling that indicates one or more time thresholds, one or more packet filters, or a combination thereof, wherein data of the data buffer corresponds to a respective traffic class of a plurality of traffic classes based at least in part on at least one of the one or more time thresholds or the one or more packet filters.

20. A non-transitory computer-readable medium storing code for wireless communications, the code comprising instructions executable by one or more processors to:
receive configuration signaling that indicates first logical channel prioritization information for a first traffic class of a logical channel and second logical channel prioritization information for a second traffic class of the logical channel;
receive an uplink grant indicating an uplink resource; and
transmit, via the uplink resource, a subset of data from a data buffer based at least in part on:
the subset of data corresponding to the first traffic class, and
the first logical channel prioritization information indicating at least one of support for the uplink grant or a priority value of the subset of data.
